(19) United States
(12) Patent Application Publication
(10) Pub. No.: US 2021/0383580 A1
(43) Pub. Date: Dec. 9, 2021

(54) METHOD, APPARATUS AND SYSTEM FOR ANCHOR SHARING, ELECTRONIC DEVICE AND STORAGE MEDIUM

(71) Applicant: Zhejiang SenseTime Technology Development Co., Ltd., Hangzhou (CN)

(72) Inventors: Jiacheng JIN, Hangzhou (CN); Jinyi Liao, Hangzhou (CN); Weijian Xie, Hangzhou (CN); Guofeng Zhang, Hangzhou (CN)

(21) Appl. No.: 17/407,214

(22) Filed: Aug. 20, 2021

Related U.S. Application Data
(63) Continuation of application No. PCT/CN2020/080481, filed on Mar. 20, 2020.

(30) Foreign Application Priority Data
Jun. 26, 2019 (CN) 201910562547.3

(51) Int. Cl. G06T 11/00; G06T 7/73; G06K 9/62; H04L 29/08; H04L 29/06

(52) U.S. Cl. CPC G06T 11/00; G06T 7/73; H04L 67/38; H04L 67/18; G06K 9/6202

(57) ABSTRACT

The disclosure relates to a method, apparatus and system for anchor sharing, an electronic device and a storage medium. The method for anchor sharing includes: receiving, by a server, an anchor sharing request from a terminal, wherein the anchor sharing request comprises information associated with a present scene scanned by the terminal and an identifier of a to-be-shared anchor acquired by the terminal; determining, by the server, shared position information of the to-be-shared anchor in the present scene according to the anchor sharing request; and transmitting, by the server, the shared position information to the terminal.

### CROSS-REFERENCE TO RELATED APPLICATIONS

This is a continuation of International Application No. PCT/CN2020/080481, filed on Mar. 20, 2020, which claims priority to Chinese Patent Application No. 201910562547.3, filed to the National Intellectual Property Administration, PRC on Jun. 26, 2019 and entitled “Method, Apparatus and System for Anchor Sharing, Electronic Device and Storage Medium”. The contents of International Application No. PCT/CN2020/080481 and Chinese Patent Application No. 201910562547.3 are incorporated herein by reference in their entireties.

### BACKGROUND

In the AR technology, real-world information may be combined with virtual-world information, and virtual visual information may be displayed in a real-world image via a device. How to enable multiple users to see the same virtual world and real world in their respective screens is crucial to the AR technology.

### SUMMARY

The disclosure relates to the technical field of Augmented Reality (AR), and more particularly, to a method, apparatus and system for anchor sharing, an electronic device and a storage medium.

According to a first aspect of the disclosure, provided is a method for anchor sharing including: receiving, by a server, an anchor sharing request from a terminal, wherein the anchor sharing request includes information associated with a present scene scanned by the terminal and an identifier of a to-be-shared anchor acquired by the terminal; determining, by the server, shared position information of the to-be-shared anchor in the present scene according to the anchor sharing request; and transmitting, by the server, the shared position information to the terminal.

According to a second aspect of the disclosure, provided is a method for anchor sharing, including: acquiring, by a terminal, an identifier of a to-be-shared anchor; sending, by the terminal, an anchor sharing request to a server according to a present scene and the identifier, wherein the anchor sharing request is configured to instruct the server to determine shared position information of the to-be-shared anchor in the present scene; and receiving, by the terminal, the shared position information fed back from the server.

According to a third aspect of the disclosure, provided is a method for anchor sharing including: acquiring, by a terminal, an identifier of a to-be-shared anchor; sending, by the terminal, an anchor sharing request to a server according to a present scene and the identifier; determining, by the server, shared position information of the to-be-shared anchor in the present scene according to the anchor sharing request; and receiving, by the terminal, the shared position information fed back from the server.

According to a fourth aspect of the disclosure, provided is an apparatus for anchor sharing, applied to a server, and including: an anchor sharing request receiving module, configured to receive an anchor sharing request from a terminal, wherein the anchor sharing request includes information associated with a present scene scanned by the terminal and an identifier of a to-be-shared anchor acquired by the terminal; a shared position information determination module, configured to determine shared position information of the to-be-shared anchor in the present scene according to the anchor sharing request; and a transmission module, configured to transmit the shared position information to the terminal.

According to a fifth aspect of the disclosure, provided is an apparatus for anchor sharing, applied to a terminal, and including: an identifier acquisition module, configured to acquire an identifier of a to-be-shared anchor; an anchor sharing request sending module, configured to send an anchor sharing request to a server according to a present scene and the identifier, wherein the anchor sharing request is configured to instruct the server to determine shared position information of the to-be-shared anchor in the present scene; and a shared position information receiving module, configured to receive the shared position information fed back from the server.

According to a sixth aspect of the disclosure, provided is a system for anchor sharing, including: a first apparatus for anchor sharing of the third aspect, and a second apparatus for anchor sharing of the fourth aspect, wherein the first apparatus for anchor sharing and the second apparatus for anchor sharing interact with each other via an anchor sharing request.

According to a seventh aspect of the disclosure, provided is a server, including: a processor; and a memory, configured to store processor-executable instructions, wherein the processor is configured to call the instructions stored in the memory to: receive an anchor sharing request from a terminal, wherein the anchor sharing request comprises information associated with a present scene scanned by the terminal and an identifier of a to-be-shared anchor acquired by the terminal; determine shared position information of the to-be-shared anchor in the present scene according to the anchor sharing request; and transmit the shared position information to the terminal.

According to an eighth aspect of the disclosure, provided is a terminal, including: a processor; and a memory, configured to store processor-executable instructions, wherein the processor is configured to call the instructions stored in the memory to perform the method of the second aspect.

According to an aspect of the disclosure, provided is a computer-readable storage medium having computer program instructions stored thereon, the computer program instructions, when being executed by a processor, implement the method of the first aspect.

According to an aspect of the disclosure, provided is a computer-readable storage medium having computer program instructions stored thereon, the computer program instructions, when being executed by a processor, implement the method of the second aspect.

According to an aspect of the disclosure, provided is computer program, including a computer-readable code which, when running in an electronic device, enables a processor in the electronic device to execute any of the above methods.

It is to be understood that the above general description and detailed description below are only exemplary and explanatory and are not intended to limit the disclosure. According to the following detailed description on the exemplary embodiments with reference to the accompanying drawings, other characteristics and aspects of the disclosure would become apparent.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 illustrates a flowchart of a method for anchor sharing according to an embodiment of the disclosure.

FIG. 2 illustrates a flowchart of a method for anchor sharing according to an embodiment of the disclosure.

FIG. 3 illustrates a flowchart of a method for anchor sharing according to an embodiment of the disclosure.

FIG. 4 illustrates a schematic diagram of a coordinate system of an anchor scene according to an embodiment of the disclosure.

FIG. 5 illustrates a schematic diagram of a coordinate system of a present scene according to an embodiment of the disclosure.

FIG. 6 illustrates a flowchart of a method for anchor sharing according to an embodiment of the disclosure.

FIG. 7 illustrates a flowchart of a method for anchor sharing according to an embodiment of the disclosure.

FIG. 8 illustrates a schematic diagram of an application example of the disclosure.

FIG. 9 illustrates a schematic diagram of an application example of the disclosure.

FIG. 10 illustrates a block diagram of an apparatus for anchor sharing according to an embodiment of the disclosure.

FIG. 11 illustrates a block diagram of an apparatus for anchor sharing according to an embodiment of the disclosure.

FIG. 12 illustrates a block diagram of a system for anchor sharing according to an embodiment of the disclosure.

FIG. 13 illustrates a block diagram of an electronic device according to embodiments of the disclosure.

FIG. 14 illustrates a block diagram of an electronic device according to embodiments of the disclosure.

### DETAILED DESCRIPTION

Various exemplary embodiments, features and aspects of the disclosure will be described below in detail with reference to the accompanying drawings. A same numeral in the accompanying drawings indicates components with a same or similar function. Although various aspects of the embodiments are illustrated in the accompanying drawings, the accompanying drawings are unnecessarily drawn to scale, unless otherwise specified.

As used herein, the word “exemplary” means “serving as an example, as an embodiment, or being illustrative”. Thus, any embodiment described herein as “exemplary” is not necessarily to be construed as preferred or better than other embodiments.

The term “and/or” in this specification is only an association relationship for describing associated objects and represents that three relationships may exist. For example, A and/or B may represent the following three cases: only A exists, both A and B exist, and only B exists. In addition, the term “at least one” herein represents any one of multiple items or any combination of at least two of the multiple items. For example, at least one of A, B and C may represent any one or multiple elements selected from a set formed by A, B and C.

In addition, for describing the disclosure better, many specific details are presented in the following detailed description. It is to be understood by those skilled in the art that the disclosure may still be implemented even without some specific details. In some examples, methods, means, components and circuits well known to those skilled in the art are not described in detail, to highlight the subject of the disclosure.

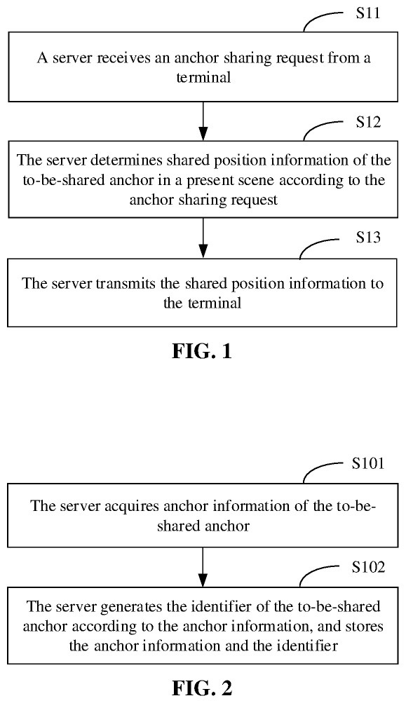

FIG. 1 illustrates a flowchart of a method for anchor sharing according to an embodiment of the disclosure. The method may be applied to a server. The specific type, model and implementation of the server are not limited, and may be flexibly selected according to actual conditions.

As illustrated in FIG. 1, the method for anchor sharing may include the following actions.

In S11, a server receives an anchor sharing request from a terminal. The anchor sharing request includes information associated with a present scene scanned by the terminal and an identifier of a to-be-shared anchor acquired by the terminal.

In S12, the server determines shared position information of the to-be-shared anchor in the present scene according to the anchor sharing request.

In S13, the server transmits the shared position information to the terminal.

In the above embodiment of the disclosure, the to-be-shared anchor may be generated in an anchor generation manner after some terminal scans an anchor scene where the anchor is located. In embodiments of the disclosure, a terminal scanning the anchor scene may be referred to as a master terminal. The specific implementation of the master terminal as a terminal device is not limited and may be flexibly determined according to actual conditions. In a possible implementation, the master terminal may be User Equipment (UE), a mobile device, a user terminal, a terminal, a cell phone, a cordless phone, a Personal Digital Assistant (PDA), a handheld device, a computing device, a vehicle-mounted device, a wearable device or the like. The specific implementation for anchor generation is also not limited, and any manner in which the anchor can be generated based on a result of the master terminal scanning the anchor scene may serve as an implementation in the embodiment of the disclosure. In a possible implementation, the to-be-shared anchor may be generated by: performing feature extraction on the result of the master terminal scanning the anchor scene, and performing anchor prediction based on a neutral network. As the anchor generation manner is not limited, the number of generated to-be-shared anchors is also not limited, and may be singular or plural, which is flexibly determined according to actual conditions of the anchor scene and the specific manner of anchor generation.

In embodiments of the disclosure, a terminal sending an anchor sharing request to the server may be referred to as a slave terminal. The specific implementation of the slave terminal as a terminal device is also not limited and will not be described herein. In embodiments of the disclosure, the number of slave terminals is also not limited, and may be singular or plural. In an example, there may be one slave terminal; at this time, the server may receive an anchor sharing request from the slave terminal to realize sharing of a to-be-shared anchor between the master terminal and the slave terminal. In an example, there may be multiple slave terminals; and the specific number is not limited herein and may be flexibly selected according to actual conditions. At this time, the server may receive anchor sharing requests from the multiple slave terminals to realize sharing of a to-be-shared anchor between the master terminal and the multiple slave terminals. Besides, the slave terminal and the master terminal may be different devices, or may be one same device. In an example, when the slave terminal and the master terminal are different devices, anchor sharing among different terminal devices may be realized. As an example, multiple terminal devices may share some AR scene through the method for anchor sharing proposed in the embodiment of the disclosure. In an example, when the slave terminal and the master terminal are one same device, anchor sharing of the single terminal device among different periods may be realized. As an example, some terminal device may realize sharing of some AR scene among multiple periods through the method for anchor sharing proposed in the embodiment of the disclosure. In an example, there may be multiple slave terminals, one of the slave terminals is one same device as the master terminal, and the rest of the slave terminals are devices different from the master terminal. At this time, it can be realized that some AR scene in multiple periods is shared between multiple terminals. As an example, multiple terminal devices may share some AR scene in multiple periods through the method for anchor sharing proposed in the embodiment of the disclosure.

The specific expression form of the anchor sharing request received by the server may be flexibly determined according to actual conditions. It has been proposed in S11 that the anchor sharing request includes the information associated with the present scene scanned by the terminal and the identifier of the to-be-shared anchor acquired by the terminal. Therefore, in the embodiment of the disclosure, although the expression form of the anchor sharing request is flexible, the anchor sharing request should effectively reflect geographic information of the present scene and should be related to the identifier of the to-be-shared anchor. In a possible implementation, the anchor sharing request may include: second feature information of the present scene, the identifier of the to-be-shared anchor and an anchor sharing request message.

The second feature information of the present scene is mainly used to reflect the geographic information of the present scene, and the specific expression form and acquisition manner of the second feature information are not limited and may be flexibly selected according to actual conditions. In a possible implementation, the second feature information may be acquired in such a way that the slave terminal scans the present scene and performs feature extraction. The expression form of the identifier of the to-be-shared anchor is also not limited, and any form in which identity information of the to-be-shared anchor can be indicated may serve as the expression form of the identifier. In an example, the expression form of the identifier of the to-be-shared anchor may be an anchor number (anchor id) of the to-be-shared anchor. Likewise, the specific content and expression form of the anchor sharing request message are also not limited, and any request capable of expressing a need of anchor sharing to the server may serve as the expression form of the anchor sharing request message.

With the anchor sharing request including the second feature information, the identifier and the anchor sharing request message, while receiving the anchor sharing request message from the slave terminal, the server may determine, according to the identifier, the identity of the to-be-shared anchor requested by the slave terminal, and directly acquire the second feature information so that the shared position information is determined based on the second feature information in the server subsequently. Therefore, the number of times of interaction with the slave terminal is reduced, and the efficiency of anchor sharing is improved.

The expression form of the shared position information, finally determined by the server, of the to-be-shared anchor in the present scene is also not limited, and any expression form in which the position of the to-be-shared anchor in the present scene can be indicated may serve as the implementation of the shared position information. In an example, the position of the to-be-shared anchor in the present scene may be indicated by coordinate information.

According to the method for anchor sharing proposed in the embodiment of the disclosure, the server receives the anchor sharing request from the terminal, determines the shared position information of the to-be-shared anchor in the present scene according to the anchor sharing request, and sends the shared position information to the terminal. With this process, the complete sharing of the anchor among different terminals or among different periods may be implemented based on operations of the server, and thus multi-user sharing, single-user multi-period sharing or multi-user multi-period sharing of an AR scene may be implemented, thereby greatly improving the uniformity and sharability of the AR technology.

It has been seen from the above embodiment of the disclosure that the method for anchor sharing proposed in the embodiment of the disclosure needs to be implemented based on the anchor sharing request sent by the terminal. Sending of the anchor sharing request is also based on the acquired identifier of the to-be-shared anchor besides the present scene scanned by the terminal. Therefore, the method for anchor sharing proposed in the embodiment of the disclosure also needs to be implemented based on the identifier of the to-be-shared anchor. In a possible implementation, the identifier of the to-be-shared anchor may be generated by the server. Therefore, in a possible implementation, before the server receives the anchor sharing request from the terminal, the method may further include S10.

FIG. 2 illustrates a flowchart of a method for anchor sharing according to an embodiment of the disclosure. As illustrated in the figure, in a possible implementation, S10 may include the following actions.

In S101, the server acquires anchor information of the to-be-shared anchor.

In S102, the server generates the identifier of the to-be-shared anchor according to the anchor information, and stores the anchor information and the identifier.

In the above embodiment of the disclosure, the implementation of S101 is not limited, i.e., the manner in which the server acquires the anchor information of the to-be-shared anchor is not limited. In a possible implementation, the anchor information of the to-be-shared anchor may be uploaded to the server by the master terminal actively. In a possible implementation, the anchor information of the to-be-shared anchor may also be acquired by the server actively from the master terminal. It is to be noted that in the embodiment of the disclosure, no matter which manner is used by the server to acquire the anchor information of the to-be-shared anchor, the process of generating the anchor information of the to-be-shared anchor is completed within the master terminal, and the server only receives and stores the anchor information.

The server acquires the anchor information of the to-be-shared anchor, generates the identifier of the to-be-shared anchor according to the anchor information, and stores the anchor information and the identifier. With this process, a one-to-one corresponding relationship between the to-be-shared anchor and the identifier may be realized, so that an identity of an anchor needing to be shared may be determined by an identifier subsequently, facilitating determining an AR scene needing to be shared. Moreover, the identifier and the anchor information are stored in the server, such that the server determines the shared position information of the to-be-shared anchor in the present scene directly based on data stored in the server, without the need to read corresponding anchor information from the master terminal, thereby effectively improving the efficiency of anchor sharing.

The specific content contained in the anchor information of the to-be-shared anchor is not limited. In a possible implementation, the anchor information of the to-be-shared anchor may include: first feature information of an anchor scene where the to-be-shared anchor is located, and original position information of the to-be-shared anchor in the anchor scene. The original position information of the to-be-shared anchor in the anchor scene is used to indicate a position relationship between the to-be-shared anchor and the anchor scene, and the specific expression form of the original position information is same as the shared position information and is not limited in the embodiments of the disclosure. In an example, the original position information may also be expressed in form of coordinate information. Besides, the generation manner and expression form of the original position information of the to-be-shared anchor in the anchor scene are also not limited. In an example, the original position information may be naturally obtained while the to-be-shared anchor is generated. That is, after the master terminal scans the anchor scene, the master terminal also generates the original position information of the to-be-shared anchor in the anchor scene while generating the to-be-shared anchor.

The specific information content contained in and generation manner of the first feature information of the anchor scene where the to-be-shared anchor is located are also not limited. In a possible implementation, the first feature information may include relevant map information in a Simultaneous Localization And Mapping (SLAM) algorithm. The map information may be used in the subsequent action S12 as a reference coordinate system of the anchor scene where the to-be-shared anchor is located and a reference surrounding environment, so as to determine the shared position information. In a possible implementation, the first feature information may be obtained in such a way that the master terminal scans the anchor scene and performs feature extraction on a scan result. Besides, the expression form of the first feature information is also not limited. In an example, the first feature information may be acquired and stored in form of continuous frames by the server.

With the anchor information of the to-be-shared anchor that contains the first feature information and the original position information, environmental information of the anchor scene where the to-be-shared anchor is located and a position relationship between the to-be-shared anchor and the anchor scene may be effectively determined. Thus, in the subsequent step S12, the shared position information of the to-be-shared anchor in the present scene is effectively determined based on a comparison result of the first feature information and the present scene, in combination with the original position information.

It has been proposed in the above embodiment of the disclosure that the expression form of the identifier of the to-be-shared anchor is not limited. Therefore, how the server generates the identifier of the to-be-shared anchor according to the anchor information may be flexibly determined according to the form of the identifier. In a possible implementation, upon receiving the anchor information, the server may randomly generate an anchor id uniquely corresponding to the to-be-shared anchor to serve as the identifier, and stores the anchor information and the corresponding identifier. Once the identifier is generated, it may be indicated that the to-be-shared anchor corresponding to the identifier may be shared. Besides, in a possible implementation, action S102 may further include that the server deletes the anchor information and the identifier in response to that the anchor information and the identifier have been stored for a period long than a time threshold.

It has been proposed in the above embodiment of the disclosure that once the identifier of the to-be-shared anchor is generated, it may be indicated that the to-be-shared anchor corresponding to the identifier may be shared. Both the anchor information and the identifier of the to-be-shared anchor may be stored in the server. The to-be-shared anchor may be instantaneous, i.e., the shared anchor may be used merely in a certain or some period of time; therefore, if all to-be-shared anchors are permanently stored in the server, resource waste may be caused for the server, and the storage space of the server may be reduced and the operation efficiency of the server may be lowered. Therefore, in order to reduce the resource waste, when the anchor information and the identifier have been stored for a period longer than the time threshold, the anchor information and the identifier stored in the server may be deleted. The setting on the specific time threshold may be flexibly selected according to actual conditions and is not limited by the following embodiments of the disclosure. In an example, the time threshold may be set to be 168 hours. That is, starting from the moment when the identifier of the to-be-shared anchor is generated, the to-be-shared anchor may be shared within 168 hours. After the 168 hours, the identifier and the anchor information of the to-be-shared anchor are deleted from the server, i.e., the to-be-shared anchor cannot be shared any more.

By deleting the anchor information and the identifier from the server when the the anchor information and the identifier have been stored for a period longer than the time threshold, the to-be-shared anchor having been stored for too much time may be effectively cleared on the basis of ensuring that the to-be-shared anchor may be shared. Thus, the repeated utilization rate of the storage space of the server may be increased, and resource waste may be reduced while improving operation efficiency of the server.

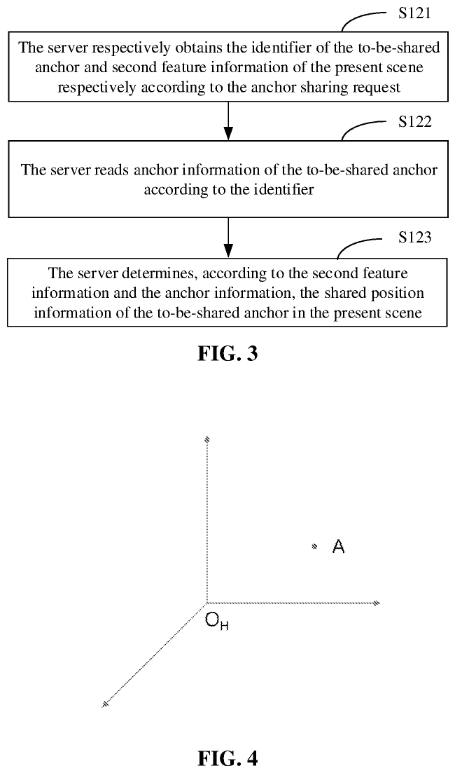

As can be seen from the above various embodiments of the disclosure, the implementation form of the anchor sharing request is not unique. As the anchor sharing request is implemented in different forms, the implementation of S12 may also vary and thus the implementation of S12 is not unique. FIG. 3 illustrates a flowchart of a method for anchor sharing according to an embodiment of the disclosure. As illustrated in the figure, in a possible implementation, S12 may include the following actions.

In S121, the server obtains the identifier of the to-be-shared anchor and second feature information of the present scene respectively according to the anchor sharing request.

In S122, the server reads anchor information of the to-be-shared anchor according to the identifier.

In S123, the server determines, according to the second feature information and the anchor information, the shared position information of the to-be-shared anchor in the present scene.

It has been proposed in the above embodiment of the disclosure that, in a possible implementation, the anchor sharing request may include the identifier of the to-be-shared anchor, the second feature information of the present scene and the anchor sharing request message. Thus, the server may obtain the identifier and the second feature information according to the anchor sharing request. It can be seen according to the above various embodiments of the disclosure that both the identifier and the corresponding anchor information may be stored in the server. Therefore, after obtaining the identifier, the server may determine the corresponding anchor information of the to-be-shared anchor according to the identifier in the anchor sharing request, and then determine the shared position information of the to-be-shared anchor in the present scene based on the anchor information and the second feature information and based on S123.

With the above process, the server may conveniently determine, through computation within the server, the position information of the to-be-shared anchor in the present scene based on the data stored in the server and the received anchor sharing request, without the need for reading data through multiple times of interaction with the terminal, thereby implementing the sharing of the AR scene at high efficiency and high accuracy.

It has been proposed in the above embodiment of the disclosure that the expression form of the shared position information may be flexibly determined according to the actual conditions. Thus, how to specifically determine, through the second feature information and the anchor information, the shared position information of the to-be-shared anchor in the present scene is not limited to the following implementation of the disclosure. In a possible implementation, S123 may include the following actions.

The server obtains, according to the anchor information, first feature information of the anchor scene where the to-be-shared anchor is located, and the original position information of the to-be-shared anchor in the anchor scene respectively.

The server performs feature matching on the first feature information and the second feature information to obtain a position transformation relationship between the present scene and the anchor scene.

The server performs position transformation on the original position information according to the position transformation relationship, to obtain the shared position information of the to-be-shared anchor in the present scene.

As can be seen from the above various embodiments of the disclosure, in a possible implementation, the anchor information may include the first feature information and the original position information. From the above embodiment of the disclosure, the first feature information may indicate the conditions of the anchor scene, and the original position information may reflect the position of the to-be-shared anchor in the anchor scene. At the same time, the second feature information may also indicate the conditions of the present scene. Thus, in a possible implementation, the position transformation relationship between the present scene and the anchor scene may be obtained by performing feature matching on the first feature information and the second feature information. In this way, after determining the position transformation relationship between the present scene and the anchor scene, the original position information is substituted into the transformation relationship, such that the shared position information of the to-be-shared anchor in the present scene may be obtained. The feature matching process may be flexibly determined according to actual expression manners of the first feature information and the second feature information. In an example, the feature matching process may include coordinate system registration between the master terminal and the slave terminal. That is, coordinate system registration between the master terminal and the slave terminal is performed based on the first feature information uploaded by the master terminal to the server and the second feature information uploaded by the slave terminal to the server. The expression form of the first feature information is the map information in the example. Thus, a transformation relationship between a coordinate system of the anchor scene corresponding to the master terminal and a coordinate system of the present scene corresponding to the slave terminal may be calculated.

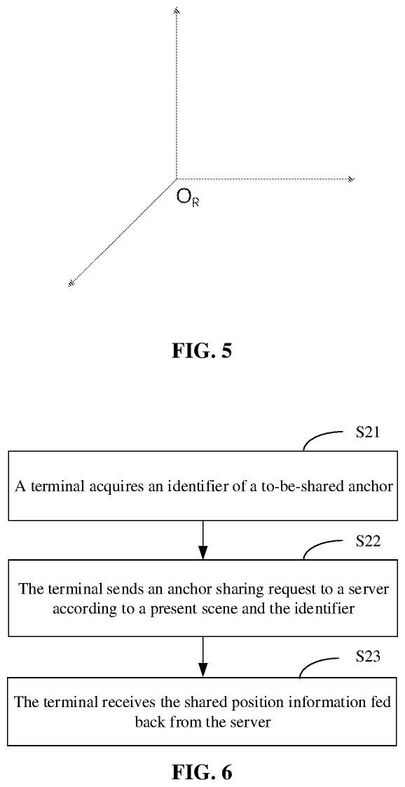

FIG. 4 illustrates a schematic diagram of a coordinate system of an anchor scene according to an embodiment of the disclosure. FIG. 5 illustrates a schematic diagram of a coordinate system of a present scene according to an embodiment of the disclosure. As can be seen from the two figures, the origin in the coordinate system of the anchor scene may be referred to as O_{H}, the point “A” is the to-be-shared anchor; and the origin in the coordinate system of the present scene may be referred to as O_{R}. In an example, the coordinate transformation relationship between the anchor scene and the present scene may be a transformation relationship M, i.e., O_{R}=O_{H}*M. Then, according to the transformation relationship, the coordinates of the to-be-shared anchor A in the present scene may be obtained, i.e., A_{R}=A_{H}*M; and the coordinates may serve as the shared position information of the to-be-shared anchor A in the present scene.

The feature matching is performed on the first feature information and the second feature information to obtain the position transformation relationship between the present scene and the anchor scene, and then position transformation is performed based on the position transformation relationship and the original position information, to obtain the shared position information of the to-be-shared anchor in the present scene. The process requires a small computational amount and is convenient in computation; and while the accuracy of determining the shared position information of the to-be-shared anchor is ensured, the computational speed of this process is greatly reduced, thereby improving the speed and efficiency of anchor sharing.

FIG. 6 illustrates a flowchart of a method for anchor sharing according to an embodiment of the disclosure. The method may be applied to a terminal device. Further, the method may be applied to the slave terminal proposed in the above embodiment of the disclosure. The number of slave terminals, and the implementation and the like of the slave terminal are not limited, which may refer to the above various embodiments of the disclosure and will not be described herein.

As illustrated in FIG. 6, in a possible implementation, the method for anchor sharing may include the following actions.

In S21, a terminal acquires an identifier of a to-be-shared anchor.

In S22, the terminal sends an anchor sharing request to a server according to a present scene and the identifier. The anchor sharing request is configured to instruct the server to determine shared position information of the to-be-shared anchor in the present scene.

In S23, the terminal receives the shared position information fed back from the server.

In the above embodiment of the disclosure, the identifier of the to-be-shared anchor that is acquired by the terminal is consistent with the identifier proposed in the above various embodiments of the disclosure, and will not be described herein. Meanwhile, the anchor sharing request sent from the terminal to the server is consistent with the anchor sharing request received by the server proposed in the above various embodiments of the disclosure, and will not be described herein. The shared position information received by the terminal that is fed back from the server is consistent with the shared position information fed back from the server to the terminal proposed in the above various embodiments of the disclosure, and will not be described herein.

The terminal acquires the identifier of the to-be-shared anchor, sends the anchor sharing request to the server according to the present scene and the identifier, and then receives the shared position information fed back from the server. With the above process, with the need of only acquiring the present scene and the identifier of the target anchor, the terminal may acquire the shared position information of the to-be-shared anchor in the present scene by communicating with the server, thereby implementing the sharing of the AR scene. The sharing manner is simple and highly efficient, and is suitable for popularization.

In the above process, the implementation S21 is not limited, that is, the manner in which the server acquires the identifier of the to-be-shared anchor is not limited. It has been proposed in the above embodiment of the disclosure that the subject implementing S21 in the embodiment of the disclosure may be the slave terminal, and the identifier of the to-be-shared anchor is generated based on information interaction between the master terminal and the server and is stored in the server in a possible implementation. In a possible implementation, the server may return the generated identifier of the to-be-shared anchor to the master terminal. It has also been proposed in the above embodiment of the disclosure that the master terminal and the slave terminal may be one same device, or may be the different devices. Thus, how the slave terminal specifically acquires the identifier of the to-be-shared anchor is not limited in the embodiment of the disclosure. Any manner in which the slave terminal can be enabled to acquire the identifier may serve as the implementation in the embodiment of the disclosure.

In a possible implementation, S21 may include the following actions: the terminal acquires shared information; and the terminal obtains the identifier of the to-be-shared anchor according to a corresponding relationship between the shared information and the identifier.

In the above process, the expression form of the shared information is not limited, and any form of information that can be mapped to the identifier and can be shared may serve as the implementation of the shared information. The corresponding relationship between the shared information and the identifier may be flexibly set according to actual conditions, and is not limited to the following embodiments of the disclosure. In a possible implementation, the expression form of the shared information may be a room number set in the process of sharing the AR scene, namely, the room number is bound with the identifier. In an example, after acquiring the shared room number, the terminal may automatically acquire the identifier corresponding to the room number while entering the room. In a possible implementation, the expression form of the shared information may be a user identity in the sharing process of the AR scene, namely, the user identity is bound with the identifier. In an example, after acquiring the shared user identity, the terminal may automatically acquire the identifier bound with the user identity. In a possible implementation, the expression form of the shared information may be the identifier directly, namely, the identifier per se may be acquired by the terminal by serving as content of the shared information. The manner in which the terminal acquires the shared information is also not limited, and may be flexibly selected according to actual conditions. In an example, the terminal as the slave terminal, may not be one same device as the master terminal; at this time, the manner in which the slave terminal acquires the shared information may be to acquire the shared information that is shared by the master terminal. In an example, the terminal as the slave terminal may be one same device as the master terminal; at this time, the manner in which the slave terminal acquires the shared information may be to directly read the shared information from the master terminal.

The terminal acquires the shared information, and obtains the identifier of the to-be-shared anchor according to the corresponding relationship between the shared information and the identifier. With the above process, the identifier of the to-be-shared anchor may be acquired conveniently without a complex resolving process; and the identifier may be indirectly acquired via the shared information. Thus, the risk that the identifier is leaked may be reduced, and the efficiency of anchor sharing is improved while the security is ensured.

As the expression form of the identifier is not limited, and it is also proposed in the above embodiment of the disclosure that the content contained in the anchor sharing request may by expressed in a variety of forms, the implementation of S22 is also not limited. Namely, the specific implementation process that the terminal sends the anchor sharing request to the server according to the present scene and the identifier is not limited.

In a possible implementation, S22 may include the following actions. The terminal scans the present scene to acquire an image of the present scene. The terminal performs feature extraction on the image of the present scene to obtain second feature information. The terminal sends the second feature information, the identifier and an anchor sharing request message together as the anchor sharing request to the server.

In the above embodiment of the disclosure, the second feature information is consistent with the second feature information of the present scene that is contained in the anchor sharing request, and will not be described herein. Likewise, it has been proposed in the above embodiment of the disclosure that the second feature information may be obtained by scanning the present scene and performing feature extraction on the scan result. The specific process and manner of feature extraction are not limited in the embodiment of the disclosure, and any manner in which information in the present scene can be extracted to determine physical environmental feature conditions of the present scene may serve as the implementation of the feature extraction. In an example, through a trained feature extraction neutral network for extracting physical environmental feature information of the present scene, the feature extraction may be performed on the image of the present scene obtained by the terminal through scanning, thereby obtaining the feature information. In an example, through a method of Oriented Fast and Rotated Brief (ORB) feature point detection, the feature extraction may be performed on the image of the present scene that is obtained by the terminal through scanning In an example, through a Scale-Invariant Feature Transform (SIFT) algorithm, the feature extraction may be performed on the image of the present scene that is obtained by the terminal through scanning.

The terminal scans the present scene to obtain the image of the present scene, performs feature extraction on the image of the present scene to obtain the second feature information, and packs the second feature information, the identifier and the anchor sharing request message to serve as the anchor sharing request, and send the anchor sharing request to the server. In this way, while requesting the server to complete the anchor sharing, the terminal may directly transmit data needed by the server to the server without a troublesome interactive process, thereby improving the efficiency of anchor sharing.

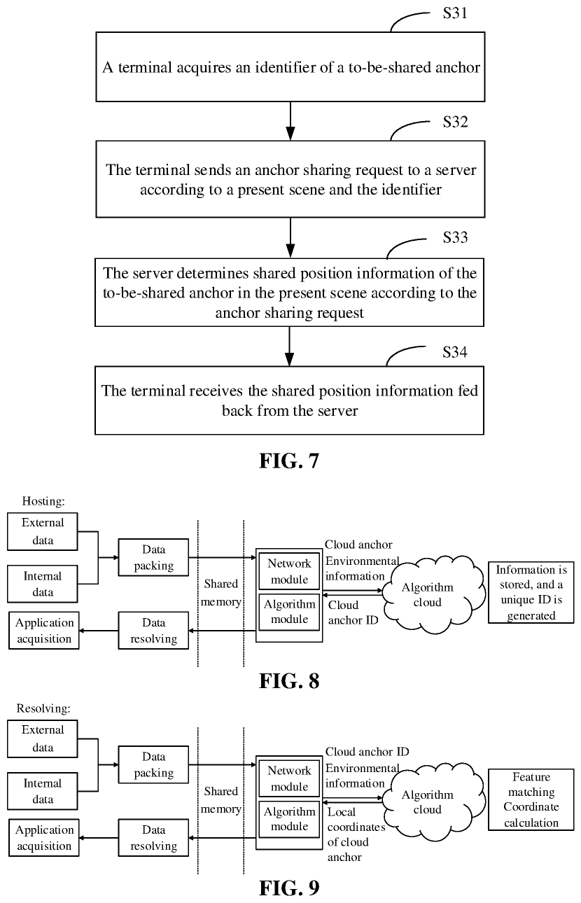

FIG. 7 illustrates a flowchart of a method for anchor sharing according to an embodiment of the disclosure. The method may be applied to a system composed of a terminal device and a server together. The implementation of the terminal and the server is consistent with the above embodiment of the disclosure, and will not be described here.

As illustrated in FIG. 7, the method for anchor sharing may include the following actions. In S31, a terminal acquires an identifier of a to-be-shared anchor. In S32, the terminal sends an anchor sharing request to a server according to a present scene and the identifier. In S33, the server determines shared position information of the to-be-shared anchor in the present scene according to the anchor sharing request. In S34, the terminal receives the shared position information fed back from the server.

In the above process, the implementation of S31 is consistent with the implementation of S21, the implementation of S32 is consistent with the implementation of S22, the implementation of S33 is consistent with the implementation of S13, and the implementation of S34 is consistent with the implementation of S23, all of which will not be described herein.

The terminal acquires the identifier of the to-be-shared anchor, and sends the anchor sharing request to the server according to the present scene and the identifier; and then, the server determines the shared position information of the to-be-shared anchor in the present scene according to the anchor sharing request, and transmits the shared position information to the terminal. With the above process, positioning of the to-be-shared anchor in the present scene may be realized by the server according to the identifier of the to-be-shared anchor, such that different terminals may share a virtual world in the same real-world scene to implement sharing of the AR technology.

Examples of Application Scenarios

The AR technology is a technology capable of combining real world information with virtual world information, and displays virtual visual information in a real world image via a device. However, AR is realized as a stand-alone version in most cases at present, and displayed in the screen of each user is a scene in which virtual world and real world information of the user per se are combined. Multiple users are unable to the same virtual world and real world in their respective screens or produce interactive AR experience.

Therefore, an AR solution capable of implementing multi-user sharing has a very important application value.

FIG. 8 and FIG. 9 illustrate a schematic diagram according to an application example of the disclosure. As illustrated in the figures, a method for anchor sharing is proposed in embodiments of the disclosure. The method for anchor sharing may be integrated into a Software Development Kit (SDK) and is implemented through cooperation between a terminal and a server. In the example of the disclosure, the process of implementing the method for anchor sharing based on the SDK may be as follows.

An enable interface is called to start an sdk cloud service. Certificate authentication is performed for the cloud service, and the cloud service is provided only when the authentication is passed. In the embodiments of the disclosure, the specific authentication process may be to add a Key/Secret applied from a developer website, so as to acquire an authority for calling the cloud service.

A user A creates an AR scene through a master terminal, creates an anchor in the scene (the anchor is located on a landmark in the real-world scene) to serve as a to-be-shared anchor, and hosts the to-be-shared anchor to a cloud server to obtain a corresponding anchor id as an identifier of the to-be-shared anchor.

An application layer manages the acquired anchor id by itself, binds the acquired anchor id with shared information and then shares the shared information to a relevant user. In the application example, this process may be completed by the cloud service.

A user B creates an AR scene for the same real-world scene, and performs an anchor resolving operation in the cloud server by using an anchor id bound with the shared information, so as to obtain the to-be-shared anchor. The position of the to-be-shared anchor relative to the real-world scene is the same as that in the case of the user A.

In the application example, FIG. 8 illustrates an implementation process for hosting a to-be-shared anchor to a cloud server, and FIG. 9 illustrates an implementation process for performing anchor resolving on a to-be-shared anchor in a cloud server. As can be seen from the figures, the hosting and resolving processes are consistent in respect of data transmission process but different in transmitted data stream. When the cloud server hosts the to-be-shared anchor, resolving and storage of data are mainly implemented; and when the cloud server resolves the to-be-shared anchor, the cloud server calls a matching algorithm to realize the resolving.

The specific process of hosting the to-be-shared anchor to the cloud server may be that: the master terminal transmits the data to the cloud server, the data including position information of the to-be-shared anchor in the anchor scene, relevant map information in the SLAM algorithm and the like. The map information serving as a reference coordinate system and a reference surrounding environment is to be used in resolving the to-be-shared anchor subsequently. The data transmitted by the master terminal are stored in the cloud server, becomes a cloud anchor and is endowed with a cloud anchor id; and the id is returned to the master terminal. The hosting of the anchor is instantaneous. Within 168 hours since the cloud anchor id is obtained, the anchor can be resolved; and after the 168 hours, relevant information of the anchor is deleted.

The process that the cloud server resolves the to-be-shared anchor may be that: the slave terminal is responsible for sending a resolving request to the cloud server to register the cloud anchor to a local coordinate system of the present slave terminal, a request data packet including feature information extracted from a picture acquired by the present slave terminal as well as an anchor id of the to-be-resolved cloud anchor. The cloud server performs feature matching on the feature information uploaded by the slave terminal and the map information uploaded by the master terminal. The matching process includes the actions of coordinate system registration between the master and slave terminals, calculating a transformation relationship between the coordinate systems of the AR scenes in the master and slave terminals, and applying the transformation result to the cloud anchor. The slave terminal receives coordinate information of the cloud anchor in the AR scene of the slave terminal.

Through the above anchor hosting and anchor resolving processes, it can be realized that different terminal devices share one or more anchors. In the present application example, the method may be applied to a multi-user sharing process of an AR scene. That is, one user hosts one or more to-be-shared anchors in the cloud server through some terminal device, and the other users may scan their respective present scenes by their respective terminal devices and acquire the position of the to-be-shared anchor in their respective terminal devices through anchor resolving in the cloud server. Thus, the anchor is displayed at the same position in the real world in the multiple terminals, thus realizing multi-user AR interaction. The method may also be applied to a single-user multi-period sharing process of an AR scene. That is, some user hosts one or more to-be-shared anchors in the cloud server through some terminal device, and thus the anchor and the anchor scene are stored in the cloud server. After a period of time, the user may further scan the anchor scene through the terminal device, reopen the anchor scene in the server by anchor resolving, acquire a to-be-shared anchor at the same position previously stored in the anchor scene, and execute needed operations. The above method may also be applied to a multi-user multi-period sharing process of an AR scene. That is, the above two application manners are combined, multiple users store the AR scene, and the same scene is displayed when the AR scene is opened by anchor resolving in a next time, without time constraints.

It can be understood that the method embodiments mentioned in the disclosure may be combined with each other to form a combined embodiment without departing from the principle and logic, which will not be described in the disclosure for the sake of simplicity.

It may be understood by the person skilled in the art that in the method in the detailed description, the writing sequence of actions does not mean a strict execution sequence to form any limit to the implementation process, and the specific execution sequence of the actions may be determined in terms of the function and possible internal logic.

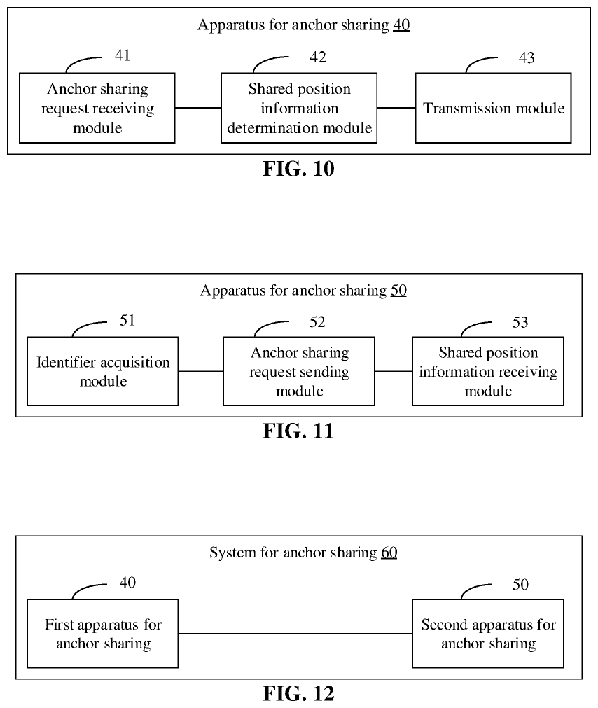

FIG. 10 illustrates a block diagram of an apparatus for anchor sharing according to embodiments of the disclosure. The apparatus for anchor sharing may be a device such as a server.

As illustrated in FIG. 10, the apparatus for anchor sharing 40 may include: an anchor sharing request receiving module 41, a shared position information determination module 42, and a transmission module 43. The anchor sharing request receiving module 41 is configured to receive an anchor sharing request from a terminal. The anchor sharing request includes information associated with a present scene scanned by the terminal and an identifier of a to-be-shared anchor acquired by the terminal. The shared position information determination module 42 is configured to determine shared position information of the to-be-shared anchor in the present scene according to the anchor sharing request. The transmission module 43 is configured to transmit the shared position information to the terminal.

In a possible implementation, prior to the anchor sharing request receiving module, the apparatus further includes an identifier generation module, configured to: acquire anchor information of the to-be-shared anchor; and generate the identifier of the to-be-shared anchor according to the anchor information, and store the anchor information and the identifier.

In a possible implementation, the identifier generation module is further configured to: enable the server to delete the anchor information and the identifier in response to that the anchor information and the identifier have been stored for a period longer than a time threshold.

In a possible implementation, the anchor information of the to-be-shared anchor includes: first feature information of an anchor scene where the to-be-shared anchor is located, and original position information of the to-be-shared anchor in the anchor scene.

In a possible implementation, the anchor sharing request includes: second feature information of the present scene, the identifier of the to-be-shared anchor and an anchor sharing request message.

In a possible implementation, the shared position information determination module is configured to: obtain the identifier of the to-be-shared anchor and second feature information of the present scene respectively according to the anchor sharing request; read anchor information of the to-be-shared anchor according to the identifier; and determine, according to the second feature information and the anchor information, the shared position information of the to-be-shared anchor in the present scene.

In a possible implementation, the shared position information determination module is further configured to: obtain, according to the anchor information, the first feature information of the anchor scene where the to-be-shared anchor is located, and the original position information of the to-be-shared anchor in the anchor scene respectively; perform feature matching on the first feature information and the second feature information to obtain a position transformation relationship between the present scene and the anchor scene; and perform position transformation on the original position information according to the position transformation relationship, to obtain the shared position information of the to-be-shared anchor in the present scene.

FIG. 11 illustrates a block diagram of an apparatus for anchor sharing according to embodiments of the disclosure. The apparatus for anchor sharing may be a device such as a terminal device.

As illustrated in FIG. 11, the apparatus for anchor sharing 50 may include an identifier acquisition module 51, an anchor sharing request sending module 52, and a shared position information receiving module 53. The identifier acquisition module 51 is configured to acquire an identifier of a to-be-shared anchor. The anchor sharing request sending module 52 is configured to send an anchor sharing request to a server according to a present scene and the identifier. The anchor sharing request is configured to instruct the server to determine shared position information of the to-be-shared anchor in the present scene. The shared position information receiving module 53 is configured to receive the shared position information fed back from the server.

In a possible implementation, the identifier acquisition module is configured to: acquire shared information; and obtain the identifier of the to-be-shared anchor according to a corresponding relationship between the shared information and the identifier.

In a possible implementation, the anchor sharing request sending module is configured to: scan the present scene to acquire an image of the present scene; perform feature extraction on the image of the present scene to obtain second feature information; and send the second feature information, the identifier and an anchor sharing request message together as the anchor sharing request to the server.

FIG. 12 illustrates a block diagram of a system for anchor sharing according to embodiments of the disclosure. As illustrated in the figure, the system 60 for anchor sharing may include: a first apparatus 40 for anchor sharing as described in the above various embodiments of the disclosure, and a second apparatus 50 for anchor sharing as described in the above various embodiments of the disclosure. The first apparatus for anchor sharing and the second apparatus for anchor sharing interact with each other via an anchor sharing request.

In embodiments of the disclosure, further proposed is a computer-readable storage medium having computer program instructions stored thereon. The computer program instructions, when being executed by a processor, implement the above method. The computer-readable storage medium may be a non-volatile computer-readable storage medium.

In embodiments of the disclosure, further provided is an electronic device, including: a processor; and a memory configured to store processor-executable instructions. The processor is configured to execute the method above.

The electronic device may be provided as a terminal, a server or other forms of devices.

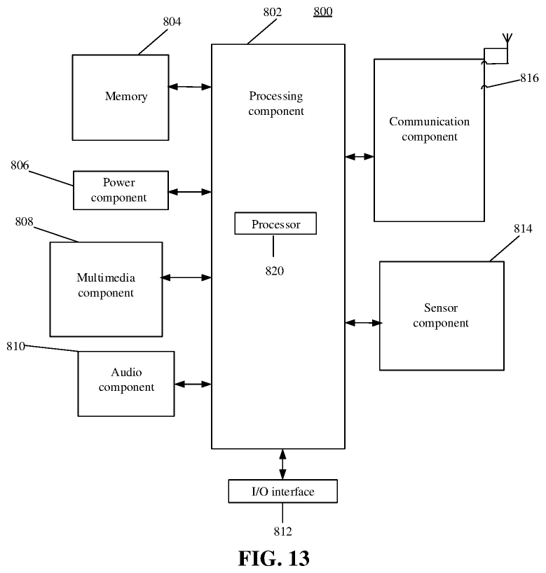

FIG. 13 illustrates a block diagram of an electronic device 800 according to embodiments of the disclosure. For example, the electronic device 800 may be a terminal such as a mobile phone, a computer, a digital broadcast terminal, a messaging device, a gaming console, a tablet, a medical device, exercise equipment and a personal digital assistant (PDA).

Referring to FIG. 13, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operation of the electronic device 800, such as the operation associated with display, telephone calls, data communications, camera operations, and recording operations. The processing component 802 may include one or more processors 820 to execute instructions to perform all or part of the actions in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the electronic device 800. Examples of such data include instructions for any application or method operating on the electronic device 800, contact data, phonebook data, messages, pictures, videos, etc. The memory 804 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power component 806 provides power to various components of the electronic device 800. The power component 806 may include a power management system, one or more power sources, and other components associated with the generation, management, and distribution of power for the electronic device 800.

The multimedia component 808 includes a screen providing an output interface between the electronic device 800 and the user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a duration and a pressure associated with the touch or swipe action. In some embodiments, the multimedia component 808 includes a front camera and/or a rear camera. The front camera and/or the rear camera may receive external multimedia data when the electronic device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a Microphone (MIC) configured to receive an external audio signal when the electronic device 800 is in an operation mode, such as a call mode, a recording mode, and a voice recognition mode. The received audio signal may further be stored in the memory 804 or transmitted via the communication component 816. In some embodiments, the audio component 810 further includes a speaker configured to output audio signals.

The I/O interface 812 provides an interface between the processing component 802 and a peripheral interface module. The peripheral interface module may be a keyboard, a click wheel, a button, or the like. The button may include, but is not limited to, a home button, a volume button, a start button, and a lock button.

The sensor component 814 includes one or more sensors to provide status assessments of the electronic device 800 in various aspects. For instance, the sensor component 814 may detect an on/off status of the electronic device 800 and relative positioning of components, such as a display and keypad of the electronic device 800, and the sensor component 814 may further detect a change in position of the electronic device 800 or a component of the electronic device 800, presence or absence of contact between the user and the electronic device 800, orientation or acceleration/deceleration of the electronic device 800, and a change in temperature of the electronic device 800. The sensor component 814 may include a proximity sensor, configured to detect the presence of nearby objects without any physical contact. The sensor component 814 may also include a light sensor, such as a Complementary Metal Oxide Semiconductor (CMOS) or Charge Coupled Device (CCD) image sensor, for use in an imaging application. In some embodiments, the sensor component 814 may also include an accelerometer sensor, a gyroscope sensor, a magnetic sensor, a pressure sensor, or a temperature sensor.

The communication component 816 is configured to facilitate wired or wireless communication between the electronic device 800 and another device. The electronic device 800 may access a communication standard based wireless network, such as a Wireless Fidelity (WiFi) network, a 2nd-Generation (2G) or 3rd-Generation (3G) network or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a Radio Frequency Identification (RFID) technology, an Infrared Data Association (IrDA) technology, an Ultra-Wideband (UWB) technology, a Bluetooth (BT) technology, and other technologies.

In exemplary embodiments, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, a non-volatile computer-readable storage medium, for example, a memory 804 including computer program instructions, is also provided. The computer program instructions may be executed by a processor 820 of an electronic device 800 to implement the abovementioned method.

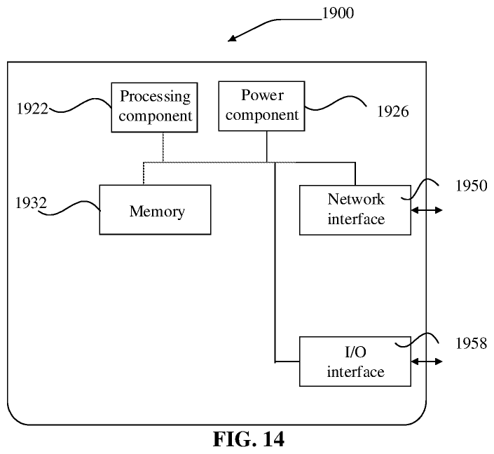

FIG. 14 illustrates a block diagram of an electronic device 1900 according to embodiments of the disclosure. For example, the electronic device 1900 may be provided as a server. Referring to FIG. 14, the electronic device 1900 includes: a processing component 1922, further including one or more processors; and a memory resource represented by a memory 1932, configured to store instructions executable by the processing component 1922, for example, an application. The application stored in the memory 1932 may include one or more modules, each corresponding to one group of instructions. In addition, the processing component 1922 is configured to execute the instructions to execute the abovementioned method.

The electronic device 1900 may further include a power component 1926 configured to execute power management of the electronic device 1900, a wired or wireless network interface 1950 configured to connect the electronic device 1900 to a network and an I/O interface 1958. The electronic device 1900 may operate based on an operating system stored in the memory 1932, for example, Windows Server™, Mac OS X™, Unix™, Linux™, FreeBSD™ or the like.

In an exemplary embodiment, a non-volatile computer-readable storage medium, for example, a memory 1932 including computer program instructions, is also provided. The computer program instructions may be executed by a processing component 1922 of an electronic device 1900 to implement the abovementioned method.

The disclosure may be a system, a method and/or a computer program product. The computer program product may include a computer-readable storage medium, in which computer-readable program instructions configured to enable a processor to implement each aspect of the disclosure is stored

The computer-readable storage medium may be a physical device capable of retaining and storing instructions used by an instruction execution device. The computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with instructions stored therein, and any appropriate combination thereof. Herein, the computer-readable storage medium is not explained as a transient signal, for example, radio waves or another freely propagating electromagnetic waves, electromagnetic waves propagating through a wave guide or another transmission medium (for example, a light pulse propagating through an optical fiber cable) or an electric signal transmitting through an electric wire.

The computer-readable program instructions described here may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, an optical fiber transmission cable, a wireless transmission cable, a router, a firewall, a switch, a gateway computer and/or an edge server. A network adapter card or network interface in each computing/processing device receives the computer-readable program instructions from the network and forwards the computer-readable program instructions for storage in the computer-readable storage medium in each computing/processing device.

The computer program instructions configured to execute the operations of the disclosure may be assembly instructions, Instruction Set Architecture (ISA) instructions, machine instructions, machine related instructions, a microcode, firmware instructions, state setting data or a source code or target code edited by one programming language or any combination of programming languages, the programming language including an object-oriented programming language such as Smalltalk and C++ and a conventional procedural programming language such as “C” language or a similar programming language. The computer-readable program instructions may be completely or partially executed in a computer of a user, executed as an independent software package, executed partially in the computer of the user and partially in a remote computer, or executed completely in the remote server or a server. In a case of a remote computer, the remote computer may be connected to the user computer via a type of network including the LAN or the WAN, or may be connected to an external computer (such as using an Internet service provider to provide the Internet connection). In some embodiments, an electronic circuit, such as a programmable logic circuit, a Field Programmable Gate Array (FPGA) or a Programmable Logic Array (PLA), is customized by using state information of the computer-readable program instructions. The electronic circuit may execute the computer-readable program instructions to realize each aspect of the disclosure.

Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of blocks in the flowcharts and/or the block diagrams may be implemented by computer-readable program instructions.

These computer-readable program instructions may be provided to a processor of a universal computer, a dedicated computer or another programmable data processing device, to produce a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium having the instructions stored thereon includes a product including instructions for realize each aspect of the function/action specified in one or more blocks in the flowcharts and/or the block diagrams.

These computer-readable program instructions may further be loaded to the computer, the other programmable data processing devices or the other devices, so that a series of operating steps are executed in the computer, the other programmable data processing devices or the other devices to generate a process implemented by the computer to further realize the function/action specified in one or more blocks in the flowcharts and/or the block diagrams by the instructions executed in the computer, the other programmable data processing devices or the other devices.

The flowcharts and block diagrams in the drawings illustrate probably implemented system architectures, functions and operations of the system, method and computer program product according to multiple embodiments of the disclosure. On this aspect, each block in the flowcharts or the block diagrams may represent part of a module, a program segment or instructions, and part of the module, the program segment or the instructions includes one or more executable instructions configured to realize a specified logical function. In some alternative implementations, the functions marked in the blocks may also occur in a sequence different from those marked in the drawings. For example, two continuous blocks may actually be executed in a substantially concurrent manner and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Various embodiments of the disclosure have been described above. The above description is exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of each embodiment or technical improvements in the market best or enable others of ordinary skill in the art to understand each embodiment disclosed herein.

1. A method for anchor sharing, comprising:
receiving, by a server, an anchor sharing request from a terminal, wherein the anchor sharing request comprises information associated with a present scene scanned by the terminal and an identifier of a to-be-shared anchor acquired by the terminal;
determining, by the server, shared position information of the to-be-shared anchor in the present scene according to the anchor sharing request; and
transmitting, by the server, the shared position information to the terminal.

2. The method of claim 1, before receiving, by the server, the anchor sharing request from the terminal, the method further comprises:
acquiring, by the server, anchor information of the to-be-shared anchor; and
generating, by the server, the identifier of the to-be-shared anchor according to the anchor information, and storing the anchor information and the identifier.

3. The method of claim 2, wherein generating, by the server, the identifier of the to-be-shared anchor according to the anchor information, and storing the anchor information and the identifier further comprises:
deleting, by the server, the anchor information and the identifier in response to that the anchor information and the identifier have been stored for a period longer than a time threshold.

4. The method of claim 2, wherein the anchor information of the to-be-shared anchor comprises:
first feature information of an anchor scene where the to-be-shared anchor is located, and original position information of the to-be-shared anchor in the anchor scene.

5. The method of claim 1, wherein the anchor sharing request comprises:
second feature information of the present scene,
the identifier of the to-be-shared anchor, and
an anchor sharing request message.

6. The method of claim 1, wherein determining, by the server, the shared position information of the to-be-shared anchor in the present scene according to the anchor sharing request comprises:
obtaining, by the server, the identifier of the to-be-shared anchor and second feature information of the present scene respectively according to the anchor sharing request;
reading, by the server, anchor information of the to-be-shared anchor according to the identifier; and
determining, by the server according to the second feature information and the anchor information, the shared position information of the to-be-shared anchor in the present scene.

7. The method of claim 6, wherein determining, by the server according to the second feature information and the anchor information, the shared position information of the to-be-shared anchor in the present scene comprises:
obtaining, by the server according to the anchor information, first feature information of an anchor scene where the to-be-shared anchor is located, and original position information of the to-be-shared anchor in the anchor scene respectively;
performing, by the server, feature matching on the first feature information and the second feature information to obtain a position transformation relationship between the present scene and the anchor scene; and
performing, by the server, position transformation on the original position information according to the position transformation relationship, to obtain the shared position information of the to-be-shared anchor in the present scene.

8. A method for anchor sharing, comprising:
acquiring, by a terminal, an identifier of a to-be-shared anchor;
sending, by the terminal, an anchor sharing request to a server according to a present scene and the identifier, wherein the anchor sharing request is configured to instruct the server to determine shared position information of the to-be-shared anchor in the present scene; and
receiving, by the terminal, the shared position information fed back from the server.

9. The method of claim 8, wherein acquiring, by the terminal, the identifier of the to-be-shared anchor comprises:
acquiring, by the terminal, shared information; and
obtaining, by the terminal, the identifier of the to-be-shared anchor according to a corresponding relationship between the shared information and the identifier.

10. The method of claim 8, wherein sending, by the terminal, the anchor sharing request to the server according to the present scene and the identifier comprises:
scanning, by the terminal, the present scene to acquire an image of the present scene;
performing, by the terminal, feature extraction on the image of the present scene to obtain second feature information; and
sending, by the terminal, the second feature information, the identifier and an anchor sharing request message together as the anchor sharing request to the server.

11. A server, comprising:
a processor; and
a memory, configured to store processor-executable instructions,
wherein the processor is configured to call the processor-executable instructions stored in the memory to:
receive an anchor sharing request from a terminal, wherein the anchor sharing request comprises information associated with a present scene scanned by the terminal and an identifier of a to-be-shared anchor acquired by the terminal;
determine shared position information of the to-be-shared anchor in the present scene according to the anchor sharing request; and
transmit the shared position information to the terminal.

12. The server of claim 11, before receiving, by the server, the anchor sharing request from the terminal, the processor is configured to call the processor-executable instructions stored in the memory to:
acquire anchor information of the to-be-shared anchor; and
generate the identifier of the to-be-shared anchor according to the anchor information, and store the anchor information and the identifier.

13. The server of claim 12, wherein in generating the identifier of the to-be-shared anchor according to the anchor information, and storing the anchor information and the identifier, the processor is configured to call the processor-executable instructions stored in the memory to:
enable the server to delete the anchor information and the identifier in response to that the anchor information and the identifier have been stored for a period longer than a time threshold.

14. The server of claim 12, wherein the anchor information of the to-be-shared anchor comprises:
first feature information of an anchor scene where the to-be-shared anchor is located, and original position information of the to-be-shared anchor in the anchor scene.

15. The server of claim 11, wherein the anchor sharing request comprises:
second feature information of the present scene,
the identifier of the to-be-shared anchor, and
an anchor sharing request message.

16. The server of claim 11, wherein in determining the shared position information of the to-be-shared anchor in the present scene according to the anchor sharing request, the processor is configured to call the processor-executable instructions stored in the memory to:
obtain the identifier of the to-be-shared anchor and second feature information of the present scene respectively according to the anchor sharing request;
read anchor information of the to-be-shared anchor according to the identifier; and
determine, according to the second feature information and the anchor information, the shared position information of the to-be-shared anchor in the present scene.

17. The server of claim 16, wherein in determining, according to the second feature information and the anchor information, the shared position information of the to-be-shared anchor in the present scene, the processor is configured to call the processor-executable instructions stored in the memory to:
obtain, according to the anchor information, first feature information of an anchor scene where the to-be-shared anchor is located, and original position information of the to-be-shared anchor in the anchor scene respectively;
perform feature matching on the first feature information and the second feature information to obtain a position transformation relationship between the present scene and the anchor scene; and
perform position transformation on the original position information according to the position transformation relationship, to obtain the shared position information of the to-be-shared anchor in the present scene.

18. A terminal, comprising:
a processor; and
a memory, configured to store processor-executable instructions,
wherein the processor is configured to call the processor-executable instructions stored in the memory to execute the method for anchor sharing of claim 8, the method for anchor sharing comprising:
acquiring an identifier of a to-be-shared anchor;
sending an anchor sharing request to a server according to a present scene and the identifier, wherein the anchor sharing request is configured to instruct the server to determine shared position information of the to-be-shared anchor in the present scene; and
receiving the shared position information fed back from the server.

19. The terminal of claim 18, wherein acquiring the identifier of the to-be-shared anchor comprises:
acquiring shared information; and
obtaining the identifier of the to-be-shared anchor according to a corresponding relationship between the shared information and the identifier.

20. The terminal of claim 18, wherein sending the anchor sharing request to the server according to the present scene and the identifier comprises:
scanning the present scene to acquire an image of the present scene;
performing feature extraction on the image of the present scene to obtain second feature information; and
sending the second feature information, the identifier and an anchor sharing request message together as the anchor sharing request to the server.
